(19) United States
(12) Patent Application Publication
(10) Pub. No.: US 2011/0172951 A1
(43) Pub. Date: Jul. 14, 2011

(54) METHODS FOR PROCESSING MEASUREMENTS FROM AN ACCELEROMETER

(75) Inventor: Stephan Schlumbohm, Aachen (DE)

(73) Assignee: KONINKLIJKE PHILIPS ELECTRONICS N.V., EINDHOVEN (NL)

(21) Appl. No.: 13/063,938

(22) PCT Filed: Sep. 18, 2009
(86) PCT No.: PCT/IB2009/054086

§ 371 Date: Mar. 15, 2011

(30) Foreign Application Priority Data
Sep. 23, 2008 (EP) 08164911.3

(51) Int. Cl. G01P 15/00

(52) U.S. Cl. 702/141

(57) ABSTRACT

There is provided a method for estimating the orientation of an accelerometer relative to a fixed reference frame, the method comprising obtaining signals from the accelerometer, the signals indicating the components of the acceleration acting on the accelerometer along three orthogonal axes; identifying the axis with the highest component of acceleration; and determining the orientation of the accelerometer by determining the angle between the acceleration acting on the accelerometer and the axis with the highest component of acceleration. There is further provided a method for estimating the vertical acceleration in the fixed reference frame using the estimated orientation.

### TECHNICAL FIELD OF THE INVENTION

The invention relates to an accelerometer that measures acceleration in three dimensions, and in particular to methods for processing the measurements from the accelerometer.

### BACKGROUND TO THE INVENTION

Generally, an object in three dimensional space has six degrees of freedom, translation along three perpendicular axes and rotation about three perpendicular axes. As the movement of the object along each of the three translational axes is independent of the other two and independent of the rotation about any of the rotational axes, the motion indeed has six degrees of freedom.

This is well known in the field of inertial sensors that conventionally several sensors are needed in order to measure and compute all six degrees of freedom of the object that is being monitored. Typically, accelerometers that can measure accelerations along the three translational axes, gyroscopes that can measure the rotations around the three rotational axes and magnetometers that can measure the orientation of the object relative to an external magnetic field are used to monitor the six degrees of freedom of the object.

In these systems, the three dimensional accelerometer can only measure three possible degrees of freedom, and in order to measure six degrees of freedom, an electronic gyroscope is used. Algorithms are used to compensate for the rotation of the accelerometer relative to an external reference frame (such as a reference frame fixed relative to the Earth) which enables the measurement of the acceleration to be converted into the Earth reference system. However, using gyroscopes has several disadvantages; firstly, gyroscopes are expensive and consume a lot of energy in comparison to an accelerometer or magnetometer, and secondly, the algorithms used to rotate the accelerometer reference system into the Earth reference system are computationally intensive.

These types of systems are often used to monitor the movement of a person by attaching a sensor unit (or units) to the body. However, the need for three different types of sensors in order to measure the six degrees of freedom of the person's movement results in an apparatus that is quite large and bulky, in addition to the disadvantages associated with using gyroscopes described above.

### SUMMARY OF THE INVENTION

It is an object of the invention to provide a method of estimating the orientation of an accelerometer in the absence of a gyroscope or other orientation sensor.

It is a further or alternative object of the invention to provide a method of estimating the acceleration in a vertical direction of an external reference frame (such as the Earth) from the measurements from the accelerometer According to a first aspect of the invention, there is provided a method for estimating the orientation of an accelerometer relative to a fixed reference frame, the method comprising obtaining signals from the accelerometer, the signals indicating the components of the acceleration acting on the accelerometer along three orthogonal axes; identifying the axis with the highest component of acceleration; and determining the orientation of the accelerometer by determining the angle between the acceleration acting on the accelerometer and the axis with the highest component of acceleration.

Preferably, the angle, θ, between the acceleration acting on the accelerometer and the axis with the highest component of acceleration is determined from

$$θ = arctan [ \frac{\sqrt{{A}_{x}^{2} + {A}_{y}^{2}}}{{A}_{z}} ]$$

where A_{z} is component of the acceleration along the axis with the highest component of acceleration, and Aₓ and A_{y} are the components of the acceleration along the other two axes.

Preferably, the method further comprises checking for local instability in an orientation determined in a particular sampling instant, i, by obtaining a set of signals from the accelerometer for a plurality of sampling instants around the particular sampling instant; and computing the variance of the norm of the components of the acceleration acting on the accelerometer along the three orthogonal axes for each of the set of signals.

Preferably, the step of computing the variance of the norm comprises calculating:

$$local\_instability ( i ) = {var}_{i - b}^{i + a} ( \sqrt{{{A}_{x} ( j )}^{2} + {{A}_{y} ( j )}^{2} + {{A}_{z} ( j )}^{2}} ) > α$$

where a+b is the number of sets of signals, and a is a value that indicates a rapid change in acceleration.

Preferably, a is a value selected from the range 15 m/s² to 20 m/s².

Preferably, acceleration due to gravity is acting on the accelerometer.

In a preferred embodiment, gravity acts in a known direction in the fixed reference frame, and the angle between the acceleration acting on the accelerometer and the axis with the highest component of acceleration provides an estimate of the orientation of the accelerometer relative to the known direction.

In a second aspect of the invention, there is provided a method for estimating the acceleration in a particular direction relative to a fixed reference frame from measurements of acceleration acting on an accelerometer, the accelerometer having an arbitrary orientation relative to the fixed reference frame, the method comprising estimating the orientation of the accelerometer relative to the fixed reference frame as described above; and using the estimated orientation of the accelerometer to determine the acceleration in the particular direction from the measurements of acceleration.

In a third aspect of the invention, there is provided a method for estimating the acceleration in a vertical direction relative to a fixed reference frame from measurements of acceleration acting on an accelerometer, the accelerometer having an arbitrary orientation relative to the fixed reference frame, the method comprising estimating the orientation of the accelerometer relative to the fixed reference frame as described above; and using the estimated orientation of the accelerometer to determine the acceleration in the vertical direction from the measurements of acceleration.

Preferably, the step of using the estimated orientation comprises evaluating

acc_{—}vert=(A_{z}−g cos θ)cos θ+g, if θ>0 or there is local instability

acc_{—}vert=(g cos θ−A_{z})cos θ+g, if θ<0 or there is no local instability

where g is the magnitude of the acceleration due to gravity in the vertical direction.

According to a fourth aspect of the invention, there is provided an apparatus for estimating the orientation of an accelerometer relative to a fixed reference frame, the apparatus comprising processing means adapted to perform the methods described above.

According to a fifth aspect of the invention, there is provided an apparatus for estimating the acceleration in a vertical direction relative to a fixed reference frame from measurements of acceleration acting on an accelerometer, the accelerometer having an arbitrary orientation relative to the fixed reference frame, the apparatus comprising processing means adapted to perform the methods described above.

According to a sixth embodiment of the invention, there is provided a computer program product comprising computer executable code that, when executed on a suitable computer or processor, is adapted to perform the methods as described above.

Thus, the invention provides a method for calculating the tilt angle of the accelerometer without the need for a gyroscope or any other sensor, and a method for calculating the vertical acceleration in a fixed reference frame from the tilt angle. Provided that the movements of the accelerometer are slow (for example movements which have a vertical acceleration of no more than ±20 m/s²) the vertical acceleration calculated in accordance with the invention will be of a similar accuracy to that calculated using a system that includes a gyroscope and other sensors.

### BRIEF DESCRIPTION OF THE DRAWINGS

Embodiments of the invention will now be described, by way of example only, with reference to the following drawings, in which:

FIG. 1 is a diagram illustrating the calculation of the orientation of an accelerometer from the measured acceleration;

FIG. 2 is a flow chart illustrating a method of estimating the orientation of an accelerometer;

FIG. 3 is a diagram illustrating an accelerometer attached to a user; and

FIG. 4 is a set of graphs indicating the performance of the method according to the invention.

### DETAILED DESCRIPTION OF THE PREFERRED EMBODIMENTS

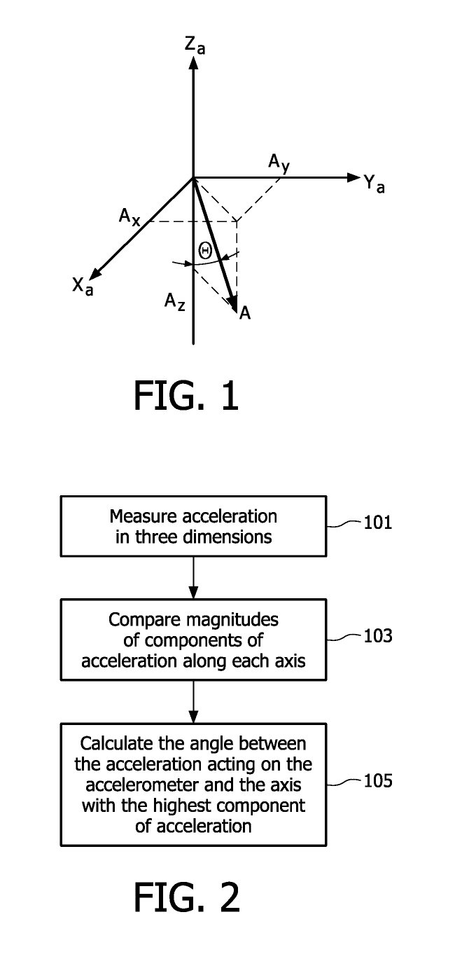

FIG. 1 is an illustration of a measurement of an acceleration A measured by an accelerometer. The accelerometer measures the acceleration A acting on it in three dimensions, and provides signals indicating the acceleration A along three orthogonal axes (labelled xₐ, yₐ and zₐ).

When the accelerometer is attached to a person or other object that is capable of movement with respect to a fixed reference frame, it is possible for the orientation of the accelerometer to change with respect to the fixed reference frame.

In this Fig., the acceleration A has components Aₓ, A_{y} and A_{z} measured along the three axes respectively.

For an accelerometer that is undergoing small or no accelerations (other than gravity), the acceleration A experienced by the accelerometer will correspond substantially to that of gravity. Thus, from this assumption, it is possible to link the acceleration A to gravity, whose direction is known in the fixed reference frame.

The orientation of the accelerometer can be estimated by calculating the angle between the acceleration A and the axis of the accelerometer that has the highest magnitude of acceleration.

A method of estimating the orientation of an accelerometer is illustrated in FIG. 2. In step 101, the accelerometer measures the acceleration acting on the accelerometer, and provides signals indicating the components of the acceleration (Aₓ, A_{y} and A_{z}) along the three orthogonal axes of the accelerometer (xₐ, yₐ and zₐ respectively).

Next, in step 103, the magnitudes of each component of the acceleration A are compared to identify the component with the highest magnitude.

In the following, the axis (xₐ, yₐ or zₐ) with the component with the highest magnitude is denoted zₐ′, and the other two axes are denoted xₐ′ and yₐ′. In this way, it is possible for the method to determine the orientation of the accelerometer regardless of the initial position of the accelerometer. For example, although it may be intended for the zₐ axis to correspond to a vertically oriented axis in the fixed reference frame, the accelerometer may not be attached to the object or person in this way (it may be that the yₐ axis corresponds most closely to the vertically oriented axis in the fixed reference frame).

It will be noted that in FIG. 1 the axis with the highest component of acceleration is zₐ, so this axis will be labelled zₐ′, and the highest component of acceleration is A_{z}.

Next, in step 105, the angle between the acceleration A and the axis with the highest component of acceleration (zₐ′) is determined. Thus, it can be seen from FIG. 1 that the angle, θ, is given by:

$$θ = arctan [ \frac{\sqrt{{A}_{x}^{2} + {A}_{y}^{2}}}{{A}_{z}} ] \qquad ( 1 )$$

If all components of the acceleration are zero (i.e. Aₓ=A_{y}=A_{z}=0) then θ and thus the orientation cannot be estimated. In this situation, the accelerometer is in free fall.

Thus, as this angle θ is determined using gravity as a reference, the angle θ can be considered as indicating the orientation of the accelerometer.

As the accelerometer is free to move with respect to the fixed reference frame, it is desirable to check for local instability caused by rapid changes in the acceleration. In this way, it is possible to compensate for errors in the determined orientation caused by these rapid changes in acceleration. In particular, local instability is checked by computing the variance of the norm of the components of the acceleration A over a period of time.

A number of signals are obtained from the accelerometer representing the acceleration at a number of sampling instants. These sampling instants preferably occur both before and after the sampling instant, i, at which the orientation of the accelerometer is calculated.

The variance of the norm of the components of the acceleration A are calculated using:

$$local\_instability ( i ) = {var}_{i - b}^{i + a} ( \sqrt{{{A}_{x} ( j )}^{2} + {{A}_{y} ( j )}^{2} + {{A}_{z} ( j )}^{2}} ) > α \qquad ( 2 )$$

where a is the number of sampling instants after the sampling instant at which the orientation of the accelerometer is calculated, b is the number of sampling instants before the sampling instant at which the orientation of the accelerometer is calculated and α is a value that indicates a rapid change in acceleration.

Preferably, α is a value selected from the range 15-20 m/s². In an even more preferred embodiment, α is 17 m/s²

In a preferred embodiment of the invention, a and b are 10.

Once the angle θ has been calculated, it is possible to determine the acceleration in a vertical direction relative to the fixed reference frame. In particular, this vertical acceleration can be used to calculate the vertical acceleration occurring, for example, when a person moves from a sitting to a standing position.

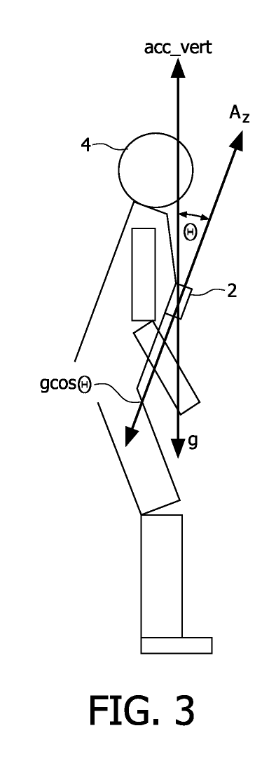

FIG. 3 shows an accelerometer 2 attached to a person 4. In this figure, the person 4 is part way through a sit to stand transfer, and the accelerometer 2 is oriented at an angle θ from the vertical. The axis with the highest component of acceleration (A_{z}) is shown.

The acceleration in the vertical direction is calculated from:

acc_{—}vert=(A_{z}−g cos θ)cos θ+g, if θ>0 or there is local instability (3)

acc_{—}vert=(g cos θ−A_{z})cos θ+_{g}, if θ<0 or there is no local instability (4)

where g is the magnitude of the acceleration due to gravity in the vertical direction. It will be appreciated that θ<0 in FIGS. 1 and 3.

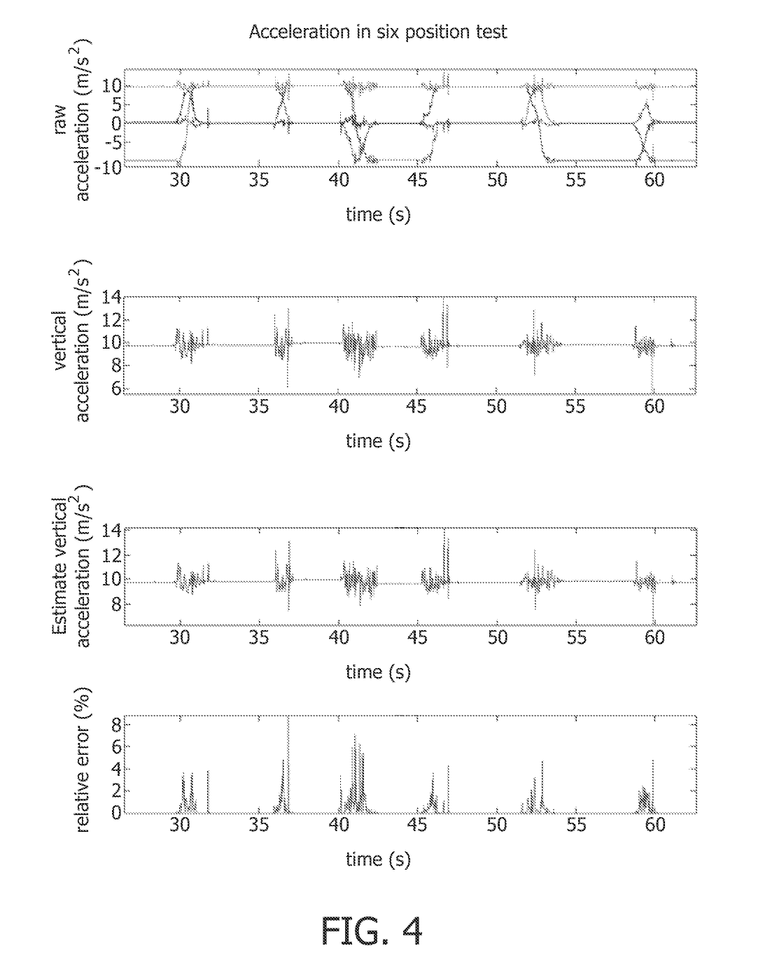

FIG. 4 is a set of graphs showing some test data used to validate the methods according to the invention. In particular, the first graph in FIG. 4 shows the signals representing the acceleration along each of the axes of the accelerometer; the second graph shows the vertical acceleration calculated using the accelerometer and a gyroscope; the third graph shows the vertical acceleration as estimated by the methods described herein; and the fourth graph shows the relative error between the second and third graphs. Thus, it can be seen that the methods according to the invention result in an error of generally less than 5% when compared to methods of determining a vertical acceleration in which gyroscopes are used.

There is therefore provided a method for calculating the tilt angle of the accelerometer without the need for a gyroscope or any other sensor, and a method for calculating the vertical acceleration in a fixed reference frame from the tilt angle. The methods for calculating the orientation and vertical acceleration can be used in any application where accelerometers and gyroscopes are normally used, and in particular can be used in devices that detect when a person has fallen, or is about to fall. As described above, the methods can also be used to determine the vertical acceleration involved in a person standing up from a sitting position.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method for estimating the orientation of an accelerometer relative to a fixed reference frame, the method comprising:
obtaining signals from the accelerometer, the signals indicating the components of the acceleration acting on the accelerometer along three orthogonal axes;
identifying the axis with the highest component of acceleration; and
determining the orientation of the accelerometer by determining the angle between the acceleration acting on the accelerometer and the axis with the highest component of acceleration.

2. A method as claimed in claim 1, wherein the angle, θ, between the acceleration acting on the accelerometer and the axis with the highest component of acceleration is determined from
$$θ = arctan [ \frac{\sqrt{{A}_{x}^{2} + {A}_{y}^{2}}}{{A}_{z}} ]$$
where A_{z} is component of the acceleration along the axis with the highest component of acceleration, and Aₓ and A_{y} are the components of the acceleration along the other two axes.

3. A method as claimed in claim 1, further comprising checking for local instability in an orientation determined in a particular sampling instant, i, by:
obtaining a set of signals from the accelerometer for a plurality of sampling instants around the particular sampling instant; and
computing the variance of the norm of the components of the acceleration acting on the accelerometer along the three orthogonal axes for each of the set of signals.

4. A method as claimed in claim 3, wherein the step of computing the variance of the norm comprises calculating:
$$local\_instability ( i ) = {var}_{i - b}^{i + a} ( \sqrt{{{A}_{x} ( j )}^{2} + {{A}_{y} ( j )}^{2} + {{A}_{z} ( j )}^{2}} ) > α$$
where a+b is the number of sets of signals, and α is a value that indicates a rapid change in acceleration.

5. A method as claimed in claim 4, wherein α is a value selected from the range 15 m/s² to 20 m/s².

6. A method as claimed in claim 1, wherein acceleration due to gravity is acting on the accelerometer.

7. A method as claimed in claim 6, wherein gravity acts in a known direction in the fixed reference frame, and the angle between the acceleration acting on the accelerometer and the axis with the highest component of acceleration provides an estimate of the orientation of the accelerometer relative to the known direction.

8. A method for estimating the acceleration in a particular direction relative to a fixed reference frame from measurements of acceleration acting on an accelerometer, the accelerometer having an arbitrary orientation relative to the fixed reference frame, the method comprising:
estimating the orientation of the accelerometer relative to the fixed reference frame as claimed in claim 1;
using the estimated orientation of the accelerometer to determine the acceleration in the particular direction from the measurements of acceleration.

9. A method for estimating the acceleration in a vertical direction relative to a fixed reference frame from measurements of acceleration acting on an accelerometer, the accelerometer having an arbitrary orientation relative to the fixed reference frame, the method comprising:
estimating the orientation of the accelerometer relative to the fixed reference frame as claimed in claim 7;
using the estimated orientation of the accelerometer to determine the acceleration in the vertical direction from the measurements of acceleration.

10. A method as claimed in claim 9, wherein the step of using the estimated orientation comprises evaluating:
acc_{—}vert=(A_{z}−g cos θ)cos θ+g, if θ>0 or there is local instability
acc_{—}vert=(g cos θ−A_{z})cos θ+g, if θ<0 or there is no local instability
where g is the magnitude of the acceleration due to gravity in the vertical direction.

11. An apparatus for estimating the orientation of an accelerometer relative to a fixed reference frame, the apparatus comprising:
processing means adapted to perform the steps in the method of claim 1.

12. An apparatus for estimating the acceleration in a vertical direction relative to a fixed reference frame from measurements of acceleration acting on an accelerometer, the accelerometer having an arbitrary orientation relative to the fixed reference frame, the apparatus comprising:
processing means adapted to perform the steps in the method of claim 9.

13. A computer program product comprising computer executable code that, when executed on a suitable computer or processor, is adapted to perform the steps in the methods of claim 1.
